(19) United States
(12) Patent Application Publication
(10) Pub. No.: US 2023/0271255 A1
(43) Pub. Date: Aug. 31, 2023

(54) METHOD OF FABRICATING A GRADED METALLIC STRUCTURE

(71) Applicant: AGENCY FOR SCIENCE, TECHNOLOGY AND RESEARCH, Singapore (SG)

(72) Inventors: Pei WANG et al., Singapore (SG); Cheng Cheh Dennis TAN, Singapore (SG); Kaixin Vivian LIN, Singapore (SG); Kwang Boon Desmond LAU, Singapore (SG); Wei Hock Gary TEH, Singapore (SG)

(21) Appl. No.: 18/014,066

(22) PCT Filed: Jul. 9, 2021
(86) PCT No.: PCT/SG2021/050404

§ 371 Date: Dec. 30, 2022

(30) Foreign Application Priority Data
Jul. 23, 2020 (SG) 10202007037V

(51) Int. Cl. B22F 10/28; B22F 10/38; B22F 10/37; B22F 1/00; B22F 9/08; B22F 9/04

(52) U.S. Cl. CPC B22F 10/28; B22F 1/09; B22F 9/04; B22F 9/08; B22F 10/37; B22F 10/38; B22F 2009/047; B22F 2301/052; B22F 2301/205

(57) ABSTRACT

The present disclosure generally relates to a method of fabricating a graded metallic structure by additive manufacturing and the graded metallic structure thereof. The method comprises preparing a material powder in a supply container, the material powder is partitioned into a plurality of longitudinal volumes and comprises different metallic powders, performing an additive manufacturing process comprising supplying layers of the material powder from the supply container, displacing the layers of material powder to a fabrication platform and fusing the layers of material powder on the fabrication platform to form the graded metallic structure, wherein at least one longitudinal volume has a varying transverse cross-sectional area and at least one longitudinal volume has a varying longitudinal cross-sectional area, such that the fused metallic powders in the graded metallic structure are graded along the longitudinal and the transverse. This method is proven to be effective to make graded metal parts with composition gradients in two dimensions.

### CROSS REFERENCE TO RELATED APPLICATION(S)

The present disclosure claims the benefit of Singapore Patent Application No. 10202007037V filed on 23 Jul. 2020, which is incorporated in its entirety by reference herein.

### TECHNICAL FIELD

The present disclosure generally relates to graded metallic structures. More particularly, the present disclosure describes various embodiments of a method of fabricating a graded metallic structure.

### BACKGROUND

Graded metallic structures belong to the class of functionally graded materials that may be characterized by the gradients or variations in their composition and structure. These variations gradually over the volume of the material result in corresponding changes in the properties and thus functionalities of the material. Various methods are used to fabricate the functionally graded materials, such as powder metallurgy. Powder metallurgy can be used to fabricate metallic materials from metallic powders, specifically by compacting the metallic powders followed by sintering. To fabricate graded metallic structures using powder metallurgy, the metallic powders are mixed to the desired composition before compacting and sintering. However, powder metallurgy is slow to fabricate the graded metallic structures and it is difficult to prepare the metallic powders and to control the desired compositional gradients.

Therefore, in order to address or alleviate at least one of the aforementioned problems and/or disadvantages, there is a need to provide an improved method of fabricating a graded metallic structure.

### SUMMARY

According to an aspect of the present disclosure, there is a method of fabricating a graded metallic structure. The method comprises:
preparing a material powder in a supply container, the material powder partitioned into a plurality of longitudinal volumes, the material powder comprising different metallic powders in the longitudinal volumes; and
performing an additive manufacturing process comprising:
   supplying layers of the material powder from the supply container;
   displacing the layers of material powder to a fabrication platform; and
   fusing the layers of material powder on the fabrication platform to form the graded metallic structure,
wherein at least one longitudinal volume has a varying transverse cross-sectional area and at least one longitudinal volume has a varying longitudinal cross-sectional area, such that the fused metallic powders in the graded metallic structure are graded along the longitudinal and the transverse.

A method of fabricating a graded metallic structure according to the present disclosure are thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of an apparatus for fabricating a graded metallic structure.

FIG. 2 is an illustration of a material powder for fabricating the graded metallic structure.

FIGS. 3 to 7 are illustrations of a supply container containing the material powder.

FIG. 8 is an illustration of an operation of preparing the material powder in the supply container.

FIGS. 9 and 10 are further illustrations of the apparatus for fabricating the graded metallic structure.

FIG. 11 is a table showing compositional blends of metallic powders in the material powder.

FIG. 12 is another illustration of the apparatus for fabricating the graded metallic structure.

FIGS. 13 and 14 are illustrations of the graded metallic structure.

FIGS. 15 and 16 are illustrations of compositional gradients of the graded metallic structure.

FIG. 17 is another illustration of the graded metallic structure.

### DETAILED DESCRIPTION

For purposes of brevity and clarity, descriptions of embodiments of the present disclosure are directed to a method of fabricating a graded metallic structure, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith.

References to “an embodiment / example”, “another embodiment / example”, “some embodiments / examples”, “some other embodiments / examples”, and so on, indicate that the embodiment(s) / example(s) so described may include a particular feature, structure, characteristic, property, element, or limitation, but that not every embodiment / example necessarily includes that particular feature, structure, characteristic, property, element or limitation. Furthermore, repeated use of the phrase “in an embodiment / example” or “in another embodiment / example” does not necessarily refer to the same embodiment / example.

The terms “comprising”, “including”, “having”, and the like do not exclude the presence of other features / elements / steps than those listed in an embodiment. Recitation of certain features / elements / steps in mutually different embodiments does not indicate that a combination of these features / elements / steps cannot be used in an embodiment.

As used herein, the terms “a” and “an” are defined as one or more than one. The use of “/” in a figure or associated text is understood to mean “and/or” unless otherwise indicated. The term “set” is defined as a non-empty finite organization of elements that mathematically exhibits a cardinality of at least one (e.g. a set as defined herein can correspond to a unit, singlet, or single-element set, or a multiple-element set), in accordance with known mathematical definitions. The recitation of a particular numerical value or value range herein is understood to include or be a recitation of an approximate numerical value or value range.

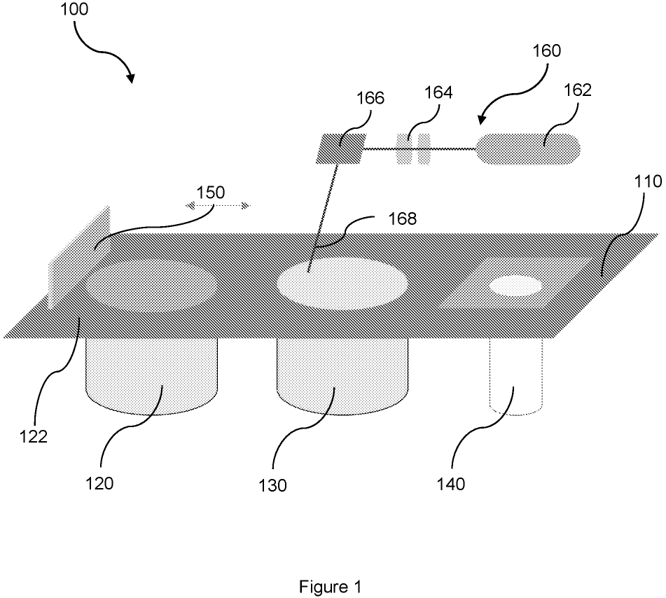

In representative or exemplary embodiments of the present disclosure, as shown in FIG. 1, there is an apparatus 100 for fabricating a graded metallic structure. As mentioned above, the graded metallic structure is a metallic material that may be characterized by the gradients in their composition and structure, resulting in corresponding changes in the properties and functionalities of the graded metallic structure.

The apparatus 100 is configured for selective laser melting or laser powder bed fusion. The apparatus 100 includes a powder bed 110, a supply container 120, a fabrication platform 130, a waste collector 140, a displacer 150, and a laser assembly 160. The supply container, which may be cylindrical in shape, contains a material powder 122. The material powder 122 includes different metallic powders for fabricating into the graded metallic structure on the fabrication platform 130 which may be cylindrical in shape. The displacer 150, also known as a recoater having a recoater blade or roller, is configured to displace the material powder 122 across the powder bed 110 from the supply container 120 to the fabrication platform 130. The waste collector 140 is arranged to collect excess material powder 122 displaced by the displacer 150 from the fabrication platform 130. The laser assembly 160 is configured to laser the material powder 122 on the fabrication platform 130 to fabricate the graded metallic structure. The laser assembly 160 includes a laser source 162, an optical lens 164, and a mirror 166 that are arranged to direct a laser beam 168 towards the fabrication platform 130.

In various embodiments, there is a method of fabricating the graded metallic structure using the apparatus 100. The method includes an operation of preparing the material powder 122 in the supply container 120 and an operation of performing an additive manufacturing process.

The additive manufacturing process, such as laser powder bed fusion, includes a step of supplying layers of the material powder 122 from the supply container 120. The additive manufacturing process includes a step of displacing, using the displacer 150, the layers of material powder 122 to the fabrication platform 130. The additive manufacturing process includes a step of fusing, using the laser assembly 160, the layers of material powder 122 on the fabrication platform 130 to form the graded metallic structure.

During the additive manufacturing process, the supply container 120 pushes a layer of material powder 122 along the longitudinal, the layer having a predefined thickness. The longitudinal is parallel to the centreline of the supply container 120 and the centreline of the fabrication platform 130. The longitudinal is preferably the vertical so the supply container 120 pushes the layer of material powder 122 upwards onto the powder bed 110.

The displacer 150 then displaces the layer of material powder 122 across the powder bed 110 to the fabrication platform 130. The fabrication platform 130 is moved along the longitudinal in a reverse direction with respect to the supply container 120 pushing the layer of material powder 122. For example, the material powder 122 is pushed upwards by the layer’s thickness by the supply container 120, and the fabrication platform 130 is moved downwards by the layer’s thickness to accommodate the layer of material powder 122.

The laser source 162 emits the laser beam 168 and the optical lens 164 and mirror 166 focus the laser beam 168 on the layer of material powder 122 at the fabrication platform 130. The laser beam 168 scans the layer of material powder 122 according to a design file digitally representing the graded metallic structure. Upon scanning by the laser beam 168, the laser beam 168 melts and fuses the material powder 122, thereby forming a layer of the graded metallic structure.

After forming the layer of graded metallic structure, the supply container 120 supplies the next layer of material powder 122 and the displacer 150 displaces it to the fabrication platform 130. The laser beam 168 then scans the next layer of material powder 122 to form the next layer of the graded metallic structure. This is an iterative process that builds the graded metallic structure layer by layer on the fabrication platform 130.

The design file, or computer aided design (CAD) file, is a configuration file that encodes one or more of the geometrical arrangement or shape of the graded metallic structure. The design file can take any now known or later developed file format. For example, the design file may be in the Stereolithography or “Standard Tessellation Language” (.stl) format, or the Additive Manufacturing File (.amf) format. Further examples of design file formats include AutoCAD (.dwg) files, Blender (.blend) files, Parasolid (.x_t) files, 3D Manufacturing Format (.3mf) files, Autodesk (3ds) files, Collada (.dae) files and Wavefront (.obj) files, although many other file formats exist.

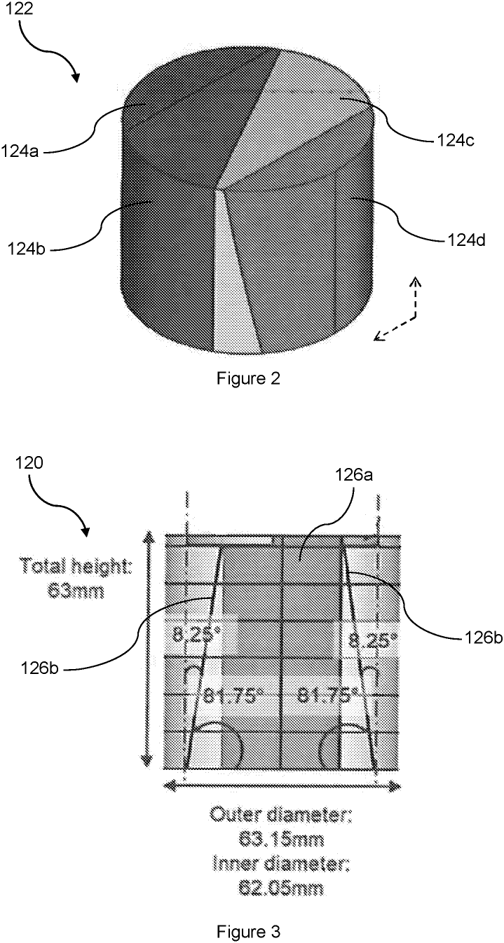

The material powder 122 in the supply container 120 is partitioned into a plurality of longitudinal volumes 124. The material powder 122 includes different metallic powders contained in the longitudinal volumes 124, such that each longitudinal volume 124 includes a respective metallic powder. For example as shown in FIG. 2, the material powder 122 is partitioned into four longitudinal volumes 124a-d. Each of the longitudinal volumes 124a-d contains a metallic powder with a specific composition. The metallic powders may be any metallic materials or alloys including one or more metallic elements from Fe, Al, Ti, Co, Cr, Ni, Cu, Ti, Ta, Cu, Nb, Sc, etc. In many embodiments, the metallic powders may include any one or any combination of a high entropy alloy (e.g. CoCrFeNi), titanium (Ti), and aluminium (Al).

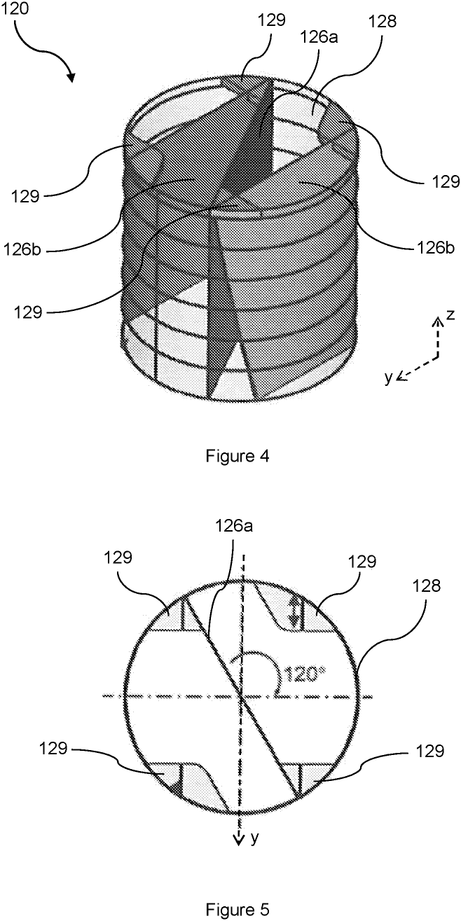

At least one longitudinal volume 124 has a varying transverse cross-sectional area, such that the fused metallic powders in the graded metallic structure are graded along the longitudinal. At least one longitudinal volume 124 has a varying longitudinal cross-sectional area, such that the fused metallic powders are graded along the transverse. Notably, the transverse (y-axis) is perpendicular to the longitudinal (z-axis), such as horizontal and vertical respectively. For example as shown in FIG. 3, each of the first and fourth longitudinal volumes 124ad has an increasing transverse cross-sectional area from the bottom to the top of the longitudinal, and each of the second and third longitudinal volumes 124bc has a decreasing transverse cross-sectional area along the same direction. The second longitudinal volume 124b has an increasing longitudinal cross-sectional area from one end to the other end of the transverse, and the third longitudinal volume 124c has a decreasing longitudinal cross-sectional area along the same direction.

The longitudinal volumes 124 may be formed by a number of dividers 126. At least one divider 126 is inclined to the longitudinal and at least one divider 126 is inclined to the transverse. For example as shown in FIG. 4, the dividers 126 include a central divider 126a and a pair of side dividers 126b. As shown in FIG. 5, the central divider 126a may be coincident with the centreline of the supply container 120, thereby dividing the supply container 120 into two halves. The central divider 126a may be inclined to the transverse, such as by 30° as shown in FIG. 5. As shown in FIG. 3, the side dividers 126b are offset from the centreline of the supply container 120. At least one side divider 126b may be inclined to the longitudinal, such as by 8.25° as shown in FIG. 3.

As an example, the supply container 120 is cylindrical with an inner diameter of 62.05 mm, outer diameter of 63.15 mm, and height of 63 mm. As shown in FIG. 5, the central divider 126a is at the inclination angle of 30° to the transverse. This inclination angle is related to the variation of the longitudinal cross-sectional areas of the longitudinal volumes 124 along the transverse. As shown in FIGS. 6 and 7, each side divider 126b has a height of 63.66 mm to fit into the supply container 120 at the inclination angle of 8.25° to the longitudinal. This inclination angle is related to the variation of the transverse cross-sectional areas of the longitudinal volumes 124 along the longitudinal. The variations of the longitudinal and transverse cross-sectional areas consequently affect the compositional gradients of the graded metallic structure.

As shown in FIGS. 4 and 5, a support structure 128 that is substantially congruent with the inner perimeter of the supply container 120 may be used to facilitate insertion of the dividers 126. Specifically, the support structure 128 has a set of guides 129 to facilitate insertion of the central divider 126a and side dividers 126b. For example, the guides 129 are slots, such as of length 8.5 mm, for insertion of the side dividers 126b therethrough. Additionally, the central divider 126a may be integrally joined to the support structure 128.

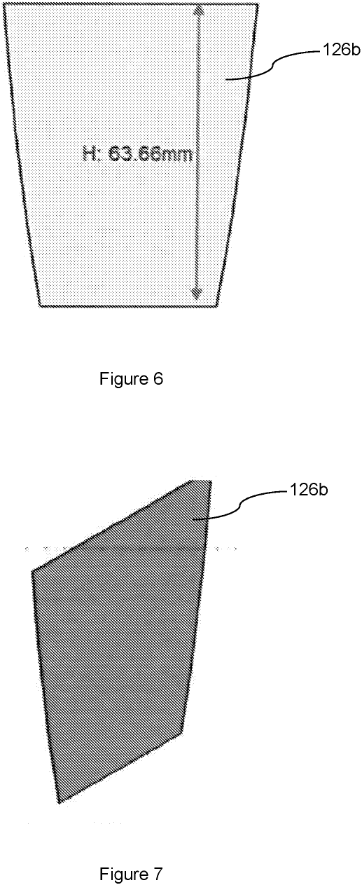

In some embodiments as shown in FIG. 8, the operation 200 of preparing the material powder 122 in the supply container 120 includes steps of inserting the dividers 126 into the supply container 120 to form the longitudinal volumes 124, filling the longitudinal volumes 124 with the respective metallic powders, and removing the dividers 126 from the supply container 120.

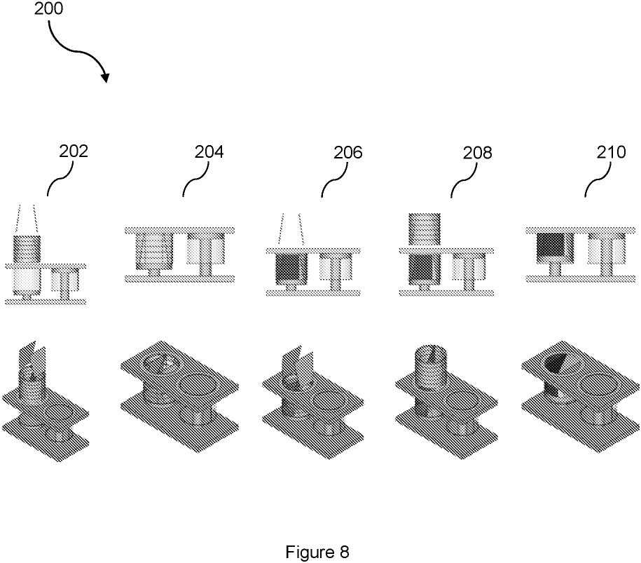

In a step 202, the central divider 126a and side dividers 126b are inserted into the supply container 120. The central divider 126a may be integrally joined to the support structure 128 such that the support structure 128 is also inserted into the supply container 120. The central divider 126a may be inserted first, as shown in FIG. 9, followed by the side dividers 126b inserted through the guides 129. In a step 204, the longitudinal volumes 124 are filled with the respective metallic powders. The support structure 128 may have demarcations to indicate the level of the metallic powders being filled into the longitudinal volumes 124. In a step 206, the side dividers 126b are removed from the supply container 120. In a step 208, the central divider 126a and support structure 128 are removed from the supply container 120. In a step 210, the supply container 120 with the material powder 122 in the respective longitudinal volumes 124 is positioned for the next operation of performing the additive manufacturing process, as shown in FIG. 10.

The dividers 126 partition the metallic powders in the respective longitudinal volumes 124 from each other during filling and prevent the different metallic powders from mixing. When the dividers 126 are removed, the resultant material powder 122 contains the partitioned metallic powders in their respective compositions. Notably, the metallic powders are graded along the longitudinal and the transverse because of the difference in powder compositions as well as the varying longitudinal and transverse cross-sectional areas of the longitudinal volumes 124.

In some embodiments, the metallic powders are pre-prepared and ready for filling into the longitudinal volumes 124. As shown in FIG. 2, the first longitudinal volume 124a is filled with a first metallic powder, the second longitudinal volume 124b is filled with a second metallic powder, the third longitudinal volume 124c is filled with a third metallic powder, and the fourth longitudinal volume 124d is filled with a fourth metallic powder. Each metallic powder includes a first metallic material and optionally a second metallic material. The second metallic material functions as a dopant to the first metallic material.

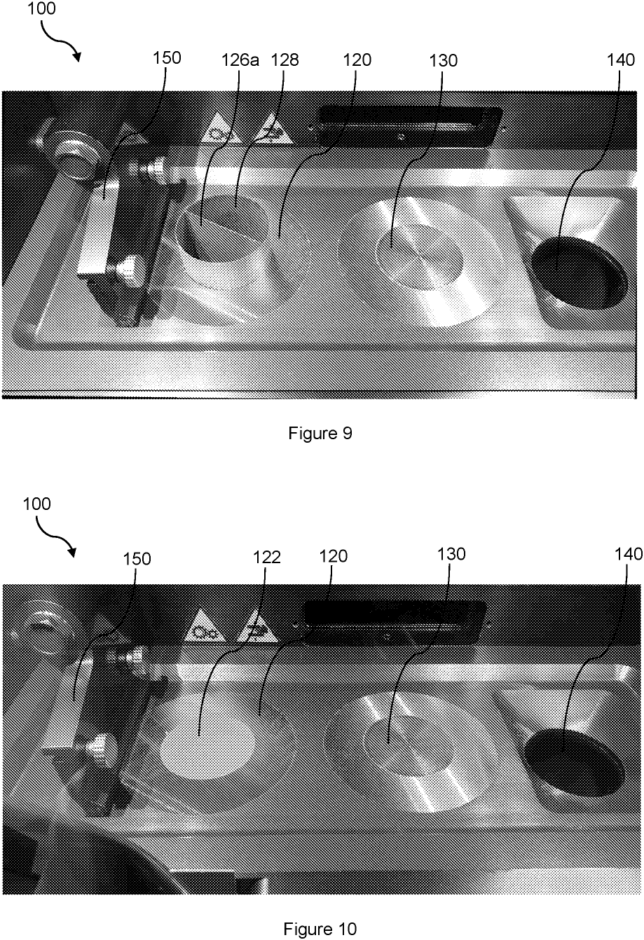

In one embodiment, the first to fourth metallic powders have specific compositions or blends as shown in FIG. 11. The first metallic material for each of the first to fourth metallic powders is CoCrFeNi alloy. The second metallic material of the first metallic powder is titanium. The second metallic material of the second metallic powder is a combination of titanium and aluminium. The second metallic material of the third metallic powder is aluminium. The fourth metallic powder does not have the second metallic material. The titanium powders are preferably at least 99.8% pure with a particle size from 20 to 50 microns. The aluminium powders are preferably at least 99.0% pure with a particle size from 20 to 50 microns. The CoCrFeNi alloy powders are preferably produced by gas atomization with a particle size from 20 to 50 microns. The respective blends of metallic powders are preferably mixed together by roller milling for a suitable duration, such as 24 hours, to achieve homogeneity in the blends.

In some embodiments, the preparation of the material powder 122 may include steps of preparing the metallic powders for the respective longitudinal volumes 124. These steps may include, for a metallic powder, forming the first metallic material by gas atomization, and mixing the first metallic material with the second metallic material by roller milling.

As the material powder 122 contains titanium in the first and second longitudinal volumes 124ab, the titanium material (or any other second metallic material) is graded along the transverse due to the varying longitudinal cross-sectional areas. As the material powder 122 contains aluminium in the second and third longitudinal volumes 124bc, the aluminium material (or any other second metallic material) is graded along the longitudinal due to the varying transverse cross-sectional areas.

Although some embodiments herein describe the first metallic material as a high entropy alloy such as CoCrFeNi alloy and the second metallic material as titanium and/or aluminium, it will be appreciated that the first and second materials can be any metallic material or alloy including one or more metallic elements from Fe, Al, Ti, Co, Cr, Ni, Cu, Ti, Ta, Cu, Nb, Sc, etc.

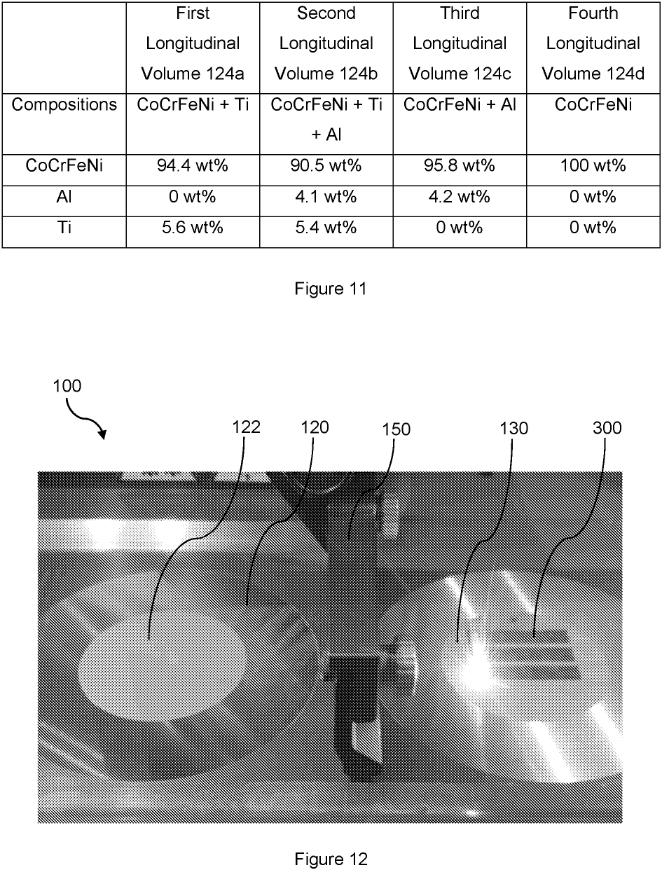

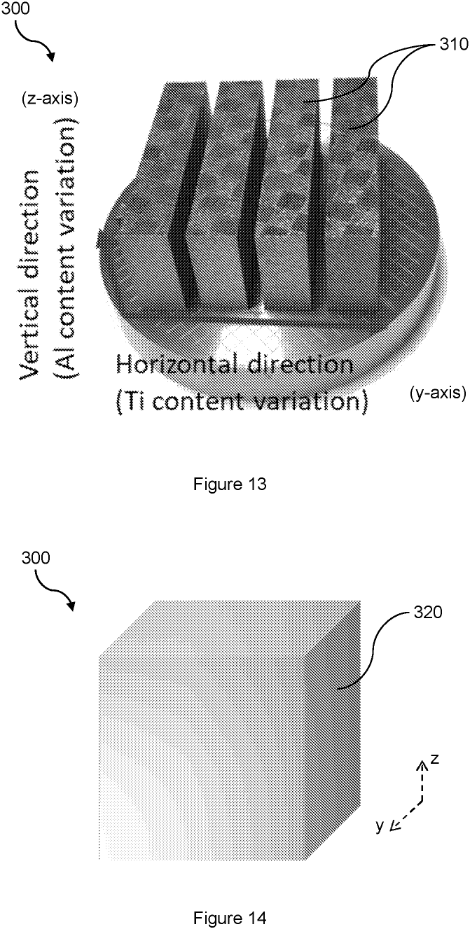

As shown in FIG. 12, the material powder 122 is fabricated into a graded metallic structure 300 via the additive manufacturing process. The graded metallic structure 300 may be in the form of an array of rectangular parts 310 as shown in FIG. 13. Alternatively, the graded metallic structure 300 may be in the form of a singular part 320 as shown in FIG. 14.

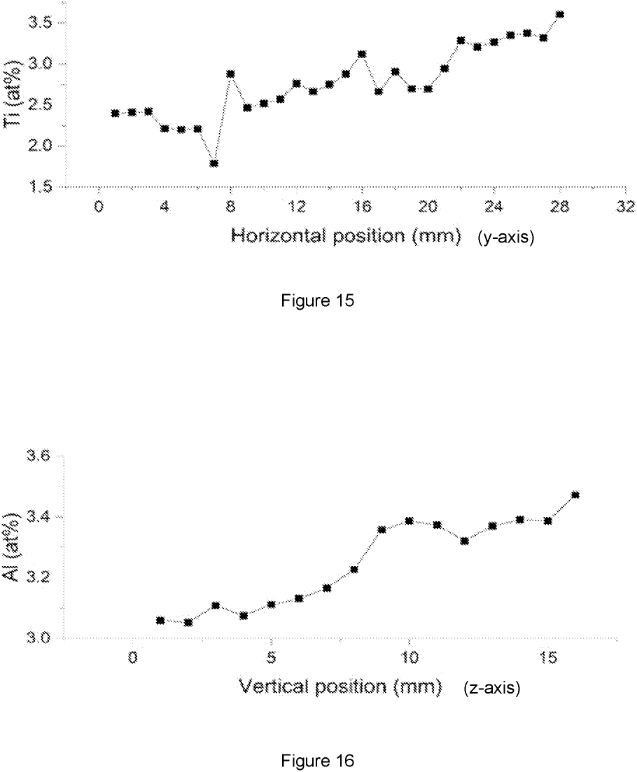

In the graded metallic structure 300, the titanium content is graded along the transverse (y-axis), and the aluminium content is graded along the longitudinal (z-axis). The compositional gradient of the titanium content is measured by X-ray analysis and shown in FIG. 15. The titanium content is broadly increasing along the transverse (horizontal) because of the increasing collective longitudinal cross-sectional area of the first and second longitudinal volumes 124ab. The compositional gradient of the aluminium content is measured by X-ray analysis and shown in FIG. 16. The aluminium content is broadly increasing along the longitudinal (vertical) because of the decreasing collective longitudinal cross-sectional area of the second and third longitudinal volumes 124bc. This is because the top layer of the material powder 122 is fabricated into the bottom layer of the graded metallic structure 300.

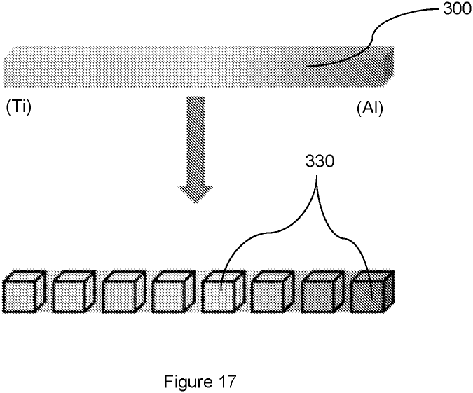

As described herein, the graded metallic structure 300 has continuous composition gradients or variations in two dimensions, such as vertical and horizontal. The graded metallic structure 300 can be used to make compositionally graded parts for various functions and applications. For example, the graded metallic structure 300 can be used for structural applications in which the service conditions of parts vary with different locations. As shown in FIG. 17, the graded metallic structure 300 may have graded constituent metallic elements, such as titanium and aluminium elements graded from respective ends thereof. The graded metallic structure 300 can be separated into a number of parts 330, such that each part 330 has a specific composition of the constituent metallic elements with corresponding properties and functionalities. For example, the end parts 330 would only contain either titanium or aluminium elements.

The method of fabricating the graded metallic structure 300 can be used to speed up processes for research and development of metallic alloys. The research and development typically include screening the compositions and material properties of the metallic alloys. Conventionally, a metallic alloy with a specific composition may be screened using permutations of 5 processing parameters and 5 heat treatment processes. This would result in performing a set of 25 tests for one metallic alloy, and 500 tests for 20 different metallic alloys. With this method, the graded metallic structure 300 can be fabricated with compositional variations across different locations thereof. By controlling the distribution of the material powder 122, the graded metallic structure 300 can be made to contain the compositions of the 20 different metallic alloys. The same set of 25 tests would only need to be performed once on the graded metallic structure 300 to screen the compositions and material properties of all 20 metallic alloys. The total number of tests is thus reduced significantly, resulting in faster development lifecycles and reduced costs.

In the foregoing detailed description, embodiments of the present disclosure in relation to a method of fabricating a graded metallic structure 300 are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art.

Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. For example, although the additive manufacturing process performed to fabricate the graded metallic structure 300 is described as selective laser melting or laser powder bed fusion, it will be appreciated that other additive manufacturing processes may be performed to fabricate the graded metallic structure 300, without departing from the scope of the present disclosure. Therefore, the scope of the disclosure as well as the scope of the following claims is not limited to embodiments described herein.

1. A method of fabricating a graded metallic structure, the method comprising:
preparing a material powder in a supply container, the material powder partitioned into a plurality of longitudinal volumes, the material powder comprising different metallic powders in the longitudinal volumes; and
performing an additive manufacturing process comprising:
supplying layers of the material powder from the supply container;
displacing the layers of material powder to a fabrication platform; and
fusing the layers of material powder on the fabrication platform to form the graded metallic structure,
wherein at least one longitudinal volume has a varying transverse cross-sectional area and at least one longitudinal volume has a varying longitudinal cross-sectional area, such that the fused metallic powders in the graded metallic structure are graded along the longitudinal and the transverse.

2. The method according to claim 1, wherein the longitudinal volumes are formed by a number of dividers, at least one divider being inclined to the longitudinal and at least one divider being inclined to the transverse.

3. The method according to claim 1, wherein preparing the material powder comprises:
inserting a number of dividers into the supply container to form the longitudinal volumes;
filling the longitudinal volumes with the respective metallic powders; and
removing the dividers from the supply container.

4. The method according to claim 3, wherein the dividers comprise a central divider coincident with a centreline of the supply container.

5. The method according to claim 4, wherein the central divider is inclined to the transverse.

6. The method according to claim 3, wherein the dividers comprise a number of side dividers offset from a centreline of the supply container.

7. The method according to claim 6, wherein at least one side divider is inclined to the longitudinal.

8. The method according to claim 3, wherein insertion of the dividers is facilitated by a support structure substantially congruent with an inner perimeter of the supply container.

9. The method according to claim 8, wherein the support structure comprises a set of guides to facilitate insertion of the dividers.

10. The method according to claim 1, wherein preparing the material powder comprises preparing the metallic powders for the respective longitudinal volumes, each metallic powder comprising a first metallic material and optionally a second metallic material.

11. The method according to claim 10, wherein preparing the metallic powder comprises mixing the first metallic material with the second metallic material by roller milling.

12. The method according to claim 10, wherein preparing the metallic powder comprises forming the first metallic material by gas atomization.

13. The method according to claim 10, wherein the first metallic material comprises a high entropy alloy.

14. The method according to claim 10, wherein the second metallic material comprises titanium and/or aluminium.

15. The method according to claim 1, wherein the additive manufacturing process is laser powder bed fusion.

16. A graded metallic structure fabricated by the method according to claim 1.
